(19) United States
(12) Patent Application Publication
(10) Pub. No.: US 2016/0209321 A1
(43) Pub. Date: Jul. 21, 2016

(54) Flow Apparatus For A Spectrometer System And Method For Operating Same

(71) Applicant: SIEMENS AKTIENGESELLSCHAFT, München (DE)

(72) Inventors: Gerit Ebelsberger, Muenchen (DE); Artur Jan Pastusiak, Boleslawiec (PL); Remigiusz Pastisiak, Muenchen (DE); Kerstin Wiesner, Höhenkirchen-Siegertsbrunn (DE)

(73) Assignee: Siemens Aktiengesellschaft, Muenchen (DE)

(21) Appl. No.: 15/025,483

(22) PCT Filed: Sep. 24, 2014
(86) PCT No.: PCT/EP2014/070290

§ 371 Date: Mar. 28, 2016

(30) Foreign Application Priority Data
Sep. 27, 2013 (DE) 10 2013 219 544.3

(51) Int. Cl. G01N 21/05; G01N 21/25; G01N 21/11

(52) U.S. Cl. CPC G01N 21/05; G01N 21/11; G01N 21/255; G01N 2021/115; G01N 2201/068; G01N 2201/025

(57) ABSTRACT

A flow apparatus for a spectrometer system includes a first optics element that is optically coupleable to a spectrometer and a second optics element that is optically coupleable to a light source. The first and second optics element may be arranged at a distance from one another in the region of a measurement gap through which a liquid can flow, in the region of which a light beam emerging from the second optics element and propagating into the first optics element is at least partly absorbable. A through-flow amount of the liquid through the measurement gap is controllable by changing the distance between the two optics elements, such that the spectrometer system can be used with various different samples.

### CROSS-REFERENCE TO RELATED APPLICATIONS

This application is a U.S. National Stage Application of International Application No. PCT/EP2014/070290 filed Sep. 24, 2014, which designates the United States of America, and claims priority to DE Application No. 10 2013 219 544.3 filed Sep. 27, 2013, the contents of which are hereby incorporated by reference in their entirety

### TECHNICAL FIELD

The invention relates to a flow apparatus for a spectrometer system and to a method for operating such a flow apparatus.

### BACKGROUND

Spectroscopy is a non-destructive method of material analysis, which operates with light with a wavelength of typically between 1 and 500,000 nm. Spectroscopy is primarily applied for the quantitative determination of known substances, their identification, for process control and monitoring and quality assurance. A spectroscopic measuring set-up contains a spectrometer to separate and measure the various light components and a measuring head for optical coupling to the sample. Depending on the measuring method, a light source is also required. Nowadays either immersion probes or flow cells are used in chemistry laboratories or in industrial processes to measure the substances or properties of liquid samples.

EP 0 300 965 A1 discloses a process cuvette for the analysis of liquids, which has a measuring chamber through which such a liquid flows with two windows disposed opposite and at a small distance from one another. A distance between the windows can be adjusted and changed with the aid of screws.

US 2008/0252881 A1 discloses an apparatus and a method for monitoring a sample, which has temperatures or pressures which deviate from the environment. A fluid path also leads here through an adjustable gap between two windows.

WO 98/20338 A1 relates to a system of performing infrared spectroscopy for the analysis of liquid foodstuffs, in which gases can be dissolved. In this process a liquid sample is routed into a measuring branch and further into a measuring cuvette. An infrared absorption spectrum is measured there. Here the measuring cuvette has a thin, round measuring chamber between two diamond-shaped windows. The distance between the two windows is fixedly provided here by a spacer disk.

DE 10 2009 037 240 A1 discloses a method and an apparatus for determining chemical and/or physical properties of operating fluids in a mechanical system. A fuel is irradiated here with infrared light from an infrared light source at right angles to a flow direction. Transmitted light is fed to an infrared spectral analyzer.

DE 10 2005 052 752 A1 relates to an apparatus for the qualitative and/or quantitative proof of molecular interactions between probes and target molecules. A reaction chamber is formed here between two opposing surfaces, wherein the distance between the first and the second surface can be changed and probe molecules in the reaction chamber are immobilized on the first surface. Alternatively or in addition to the immobilized probe molecules, at least one of the two surfaces has a displacing structure which is positioned in the region of the surface in which the detection of the target should take place. In this way the first surface can be embodied by means of two layers disposed one above the other, wherein the inner of the two layers disposed one above the other can be formed of an elastic seal or a sealing membrane.

### SUMMARY

One embodiment provides a flow apparatus for a spectrometer system, having a first optics element that is optically coupleable to a spectrometer and having a second optics element that is optically coupleable to a light source, which are arranged at a distance from one another in the region of a measurement gap through which a liquid can flow, in the region of which a light beam emerging from the second optics element and reaching the first optics element is at least partly absorbable, wherein an amount of the liquid flowing through the measurement gap is influenceable by a change in the distance between the two optics elements, and wherein at least one elastic membrane is arranged between the assigned optics element and an internal wall region of the flow apparatus, which is fastened between an edge of the measurement gap and an internal edge of the wall region.

In a further embodiment, in order to adjust the distance between the two optics elements during ongoing operation, the distance between the two optics elements can be controlled.

In a further embodiment, the distance between the two optics elements can be controlled with a micrometer screw or hydraulically.

In a further embodiment, the flow apparatus includes a control facility by which the distance between the two optics elements can be automatically increased or decreased in size as a function of a light intensity which can be measured by a measuring facility which is optically coupled to the first optics element.

In a further embodiment, a bypass system is part of the flow apparatus, by means of which a further liquid can be introduced into the measurement gap as a reference liquid.

In a further embodiment, the bypass system is configured, during operation, to firstly automatically introduce a cleaning fluid and then the reference liquid into the measurement gap.

In a further embodiment, the flow apparatus is substantially formed to be tubular.

In a further embodiment, the elastic membrane is a polymer membrane or a mixed matrix membrane.

Another embodiment provides a method for operating a flow apparatus for a spectrometer system, wherein the flow apparatus has a first optics element that is optically coupleable to a spectrometer and a second optics element that is optically coupleable to a light source, which are arranged at a distance from one another in the region of a measurement gap through which a liquid can flow, wherein in the region of the measurement gap a light beam emerging from the second optics element and reaching the first optics element is at least partly absorbed, wherein an amount of the liquid flowing through the measurement gap is influenced by a change in the distance between the two optics elements, and wherein at least one elastic membrane is arranged between the assigned optics element and an internal wall region of the flow apparatus, which is fastened between an edge of the measurement gap and an internal edge of the wall region.

### BRIEF DESCRIPTION OF THE DRAWINGS

Example embodiments are described in detail below with reference to the figures, in which:

FIG. 1 shows a schematic representation of an exemplary flow apparatus according to one embodiment of the invention;

FIG. 2 shows a schematic representation of a further exemplary flow apparatus in one embodiment of the invention;

FIG. 3 shows a schematic representation of an additional exemplary flow apparatus in one embodiment of the invention; and

FIG. 4 shows a schematic representation of the membrane shown in FIG. 3.

### DETAILED DESCRIPTION

Embodiments of the present invention enable a single spectrometer system to be used for a plurality of various samples with different optical and mechanical properties.

A flow apparatus for a spectrometer system has a first optics element that is optically coupleable to a spectrometer and a second optics element that is coupleable to a light source, which are arranged at a distance from one another in the region of a measurement gap through which a liquid can flow, wherein in the region of this measurement gap a light beam emerging from the second optics element and reaching the first optics element is at least partly absorbable by the liquid. In order to be able to use a spectrometer system equipped with an inventive flow apparatus with a plurality of different samples, an amount of the liquid flowing through the measurement gap can be influenced by a change in the distance between the two optics elements. The distance between the optics elements can in particular be changed both by a movement of one of the two optics elements or a movement of both optics elements.

This is advantageous in that an adjustment of the measurement gap to the best light efficiency from a spectroscopic point of view is enabled. Both dark and viscous substances such as lubricating oil, marine diesel fuel or emulsions such as milk and also highly fluid and light-colored samples and other process solutions can be measured with one and the same system.

In one embodiment, provision is made that in order to adjust the distance between the two optics elements during ongoing operation, the distance between the two optics elements can be controlled. The size of the measurement gap can thus be controlled during a measurement, so that from a spectroscopic point of view best light efficiency can be set. This is advantageous in that the already mentioned different substances can be measured without process interruption. The flow apparatus can thus in particular also be adjusted to inhomogeneities in the sample substance.

Provision is made in particular for the distance between the two optics elements to be controllable with a micrometer screw or hydraulically. This is advantageous in that the distance can be set very accurately and the various properties of different sample liquids can thus be effectively taken into account in fine gradations.

Provision is made in a further embodiment for a control facility to be present, with which the distance between the two optics elements can be automatically increased or decreased in size as a function of a light intensity which can be measured by a measuring facility which is optically coupled to the first optics element. Therefore depending on the light intensity which is measured in particular on the spectrometer, the bottleneck, in other words the measurement gap, in the flow apparatus is automatically constricted or enlarged. This is advantageous in that different liquids can not only be measured without process interruption with one and the same system, but instead the flow apparatus also remains metrologically flexible with respect to desired process fluctuations.

In one embodiment, provision is made for a bypass system to be part of the flow apparatus, by means of which a further liquid can be introduced into the measurement gap as a reference liquid. This is advantageous in that a reference spectrum, which is basically required for each position or each distance of the optics elements in order to evaluate data, need not be read out of a database but can instead be measured in situ in each case. A new reference spectrum can therefore be recorded for each new position of the optics elements, in that said reference liquid is firstly examined after a change in the size of the measurement gap.

Provision can further be made here for the bypass system to be configured, during operation, to firstly automatically introduce a cleaning fluid and then, subsequently, the reference liquid into the measurement gap. This is advantageous in that the reference spectrum can be recorded particularly reliably, since residues from other liquids falsifying the reference spectrum are ruled out.

In a further embodiment, provision is made for the flow apparatus to be substantially formed in a tubular manner. In particular, it can assume the shape of a capillary tube. This is advantageous in that the flow apparatus can be easily connected to existing attachments and is easy to clean. In particular, in the case of an implementation as a capillary tube it is possible if applicable, thanks to the capillary effect, to dispense with a pump or suchlike. An adjustment of the size of the measurement gap to sample properties is particularly advantageous here, since the respectively different properties of various samples can thus be taken into account in respect of the capillary effect.

At least one elastic membrane, in particular a very significantly elastic and/or deformable membrane, is arranged between the assigned optics element and an internal wall region of the flow apparatus. Here the membrane deforms with a change in the distance between the two optics elements, so that it forms a bottleneck with the optics elements, in other words the measurement gap. The selection of the material, from which the membrane is to be produced, is free here except for the requirements for elasticity and/or deformability and can be selected in a process-specific manner, in particular as a polymer membrane or as a mixed matrix membrane. The material of the membrane may be selected such that it is resilient compared with the liquids or individual components of these liquids to be examined, in other words it is not chemically attacked by these, nor by any cleaning agents used. This is advantageous in that the membrane can be used to prevent a possible collection of solid particles, as occurs in inhomogeneous liquids, on the optical elements in the flow apparatus. The cleaning of the flow apparatus, in other words the flow cell, is also significantly simplified by the use of the membrane. On the one hand, the membrane namely seals the system from leakages, on the other hand it is so elastic that with the maximum distance between the optics elements, a strong through-flow of liquid through the measurement gap and thus the flow cell is possible. This dispenses with a problematic cleaning of edges, which are disposed inside the standard flow cells. Moreover, use of the membrane prevents the formation of vortices at the bottleneck in the liquid flow realized by the measurement gap and as a result the flow of the process liquids remains laminar over a larger area.

Other embodiments provide a method for operating such a flow apparatus for a spectrometer system, wherein an amount of the liquid flowing through the measurement gap is influenced by a change in the distance between the two optics elements for instance. This results in the described advantages.

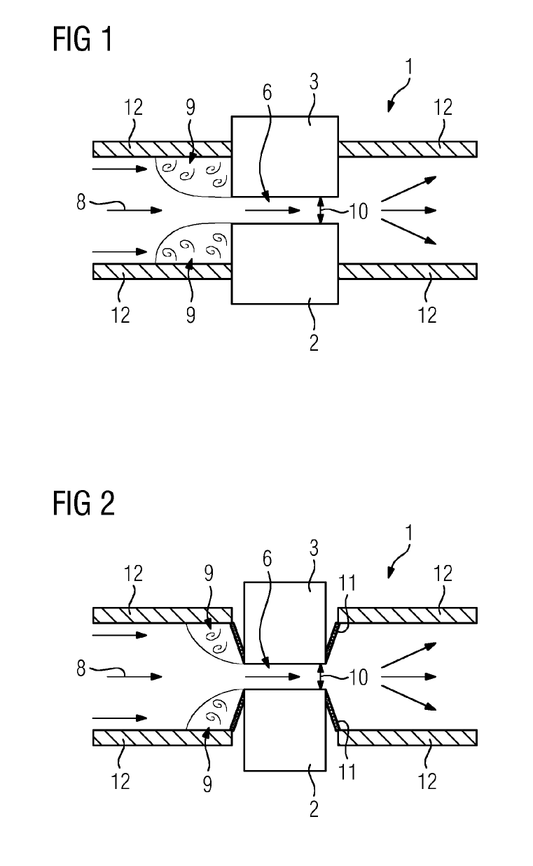

FIG. 1 shows a flow apparatus 1 according to one example embodiment. A liquid 8 flows here along a number of wall regions 12 and through a measurement gap 6 which is formed by two optics elements 2, 3 which are arranged at a distance 10 from one another. Turbulences form here in two regions 9 adjacent to the measurement gap. The optics elements 2, 3 can be moved here in parallel to the drawing plane, so that they can be changed in terms of their distance 10. The size of the measurement gap 6 can be changed as a result and the quantity of liquid 8, which can flow through the measurement gap 6 during a predetermined time, can thus be changed by a change in the distance 10 between the two optics elements 2, 3.

During operation of the flow apparatus, the liquid 8 now flows through the measurement gap 6 and at least partially absorbs light there which emerges from the second optics element 3. Only a certain portion of the light emerging from the second optics element 3 thus reaches the first optics element 2, said light portion being reduced in terms of its spectrum. If the flow apparatus 1 is now used for another liquid 8, either too much or too little light may be absorbed in the measurement gap 6 with the distance 10 set for the preceding liquid 8. If too much light is absorbed, in other words there is a significantly darker liquid for instance, the distance 10 must be reduced so that it is possible to draw conclusions from the light reaching the first optics element 2 as to the properties of the liquid 8. However if this is a very highly fluid, largely transparent liquid 8, the measurement gap 6 must be enlarged so that the quantity of liquid 8 between the two optics elements 2, 3 is sufficient in order to actually produce a measurable absorption of light. Other properties, such as for instance the viscosity of the liquid 8, can thus also be taken into account by adjusting the measurement gap 6.

FIG. 2 shows a flow apparatus 1, in which very similarly to the flow apparatus 1 shown in FIG. 1, a liquid 8 flows through a measurement gap 6 between wall regions 12 and two optics elements 2, 3. Here the two regions 9 in which vortices occur are significantly smaller than in the example shown in FIG. 1. This is attributed to a number of highly flexible membranes 11, which are arranged between the wall regions 12 and the optics elements 2, 3. In the example shown, the membranes 11 are fastened between edges of the measurement gap 6 and internal edges of the wall regions 12 of the flow apparatus 1. These membranes 11 therefore outwardly seal an interior, through which liquid 8 is passed, in other words e.g. in the direction of a mechanical system which moves the optics elements 2, 3. If the two optics elements 2, 3 are now changed in terms of their distance 10, for instance on account of changed properties of the liquid 8, the membranes 11 adjust, on account of their flexibility, to the changed geometry of the wall regions 12 and the two optics elements 2, 3. By using the membranes 11, fewer acute angles also appear in the example shown at the corner regions of the wall regions 12 and the optics elements 2, 3. This is the reason for the already mentioned advantageous reduction in size of the regions 9, in which the liquid 8 swirls.

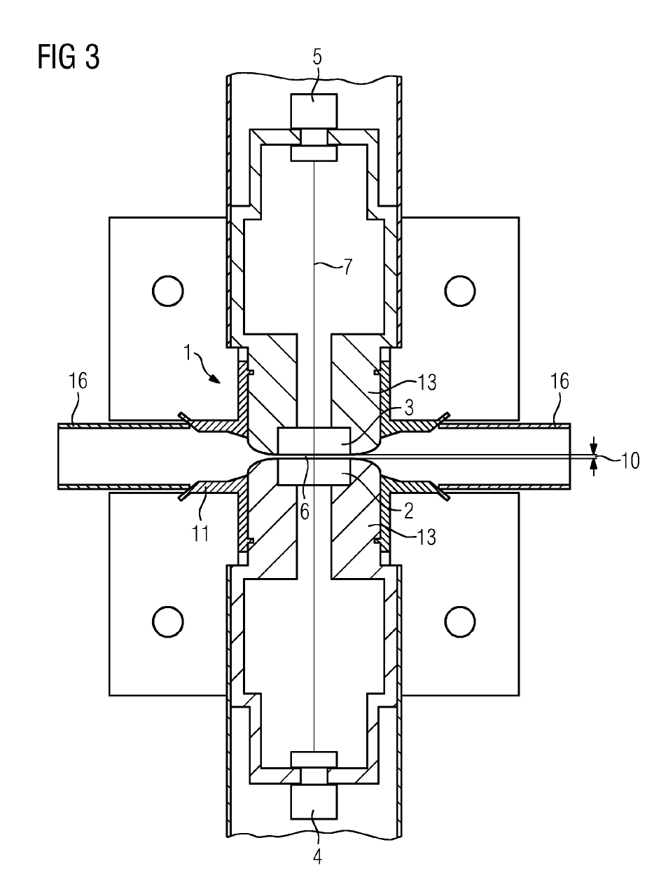

FIG. 3 shows a flow apparatus 1 in an integrated state in a spectrometer system. Here two displaceable cylinders 13 accommodate the two optics elements 2, 3 and form a mechanical guide here. The distance 10 between the two optics elements 2, 3 can be adjusted by way of this mechanical guide, for instance by way of a micrometer screw. A light beam 7 firstly reaches the second optics element 3 from a light source 5, for instance a halogen lamp or an LED element, then the measurement gap 6 and finally, via the first optics element 2, a spectrometer 4. Disposed again in the measurement gap 6 is a liquid 8 which absorbs spectral parts of the light beam 7. In the example shown the liquid 8 is routed through the measurement gap 6 via two tubes 16, which are connected to the measurement gap 6 by way of the membrane 11. If too much or too little brightness is detected in the spectrometer 4, in the example shown the measurement gap 6 can be adjusted by displacing the cylinders 13. If too much light reaches the spectrometer 4, the measurement gap 6 is increased in size, conversely if too little light reaches the spectrometer 4, the measurement gap 6 is reduced in size in order thus always, in other words for various sample substances, to ensure the best possible measurement result. The system can also be equipped for instance with a bypass system, which is set up so as to automatically provide, after a change in the distance 10 between the two optics elements 2, 3, firstly that the measurement gap 6 is flushed through with a cleaning liquid, in order as a result to introduce a reference liquid into the measurement gap 6 so that the spectrometer 4 can be adjusted or calibrated for the distance 10 now used on the basis of the reference liquid.

Following the adjustment process, the liquid 8 to be analyzed is again introduced into the measurement gap 6 by way of the two tubes 16. During operation, an analysis of various substances can thus also be performed fully automatically without further intervention from the user or e.g. the process flow can also be varied.

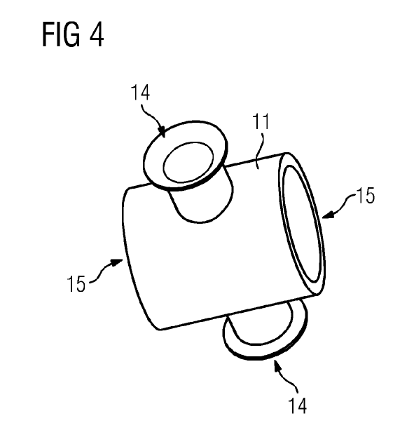

FIG. 4 shows a schematic representation of the membrane 11 used in the example shown in FIG. 3. Clearly apparent here are four openings 14, 15, wherein in each case two openings 14 and two openings 15 are arranged on opposite sides of the membrane 11. The two openings 15, which, in the present case, are the larger of the openings 14, 15, are provided to seal the flow apparatus 1 in the region of the two optics elements 2, 3 with the cylinders 13 assigned thereto. The two smaller openings 14 accommodate, as shown in FIG. 3, two tubes 16 and thus seal the flow apparatus 1 in the direction of the supply and discharge of the liquid 8 to be examined. Since the membrane 11 is significantly elastic or highly flexible, it can simultaneously adjust to a changed geometry by displacing the cylinders 13 with the optics elements 2, 3 and obtain its sealing function. Moreover, edges at which residues of the sample or other liquids and substances can accumulate are avoided by design here by way of the round shapes used.

What is claimed is:

1. A flow apparatus for a spectrometer system, the flow apparatus comprising:
a first optics element optically coupleable to a spectrometer, and
a second optics element optically coupleable to a light source,
wherein the first and second optics elements are arranged at a distance from one another to define a measurement gap configured to communicate a flow of a liquid,
wherein the measurement gap between the first and second optics elements is arranged such that a light beam propagating from the light source to the spectrometer passes through the measurement gap, wherein the light beam is at least partially absorbed by liquid flowing through the measurement gap,
wherein an amount of the liquid flowing through the measurement gap is controllable by a change in the distance between the first and second optics elements, and
at least one elastic membrane arranged between the first and second optics element and an internal wall region of the flow apparatus, the at least one elastic membrane being coupled between an edge of the measurement gap and an internal edge of the wall region.

2. The flow apparatus as of claim 1, wherein the distance between the first and second optics elements is controllable during an ongoing operation of the spectrometer system.

3. The flow apparatus of claim 2, wherein the distance between the first and second optics elements is controllable using a micrometer screw or hydraulically controllable.

4. The flow apparatus of claim 2, comprising:
a measuring device optically coupled to the first optics element and configured to measure a light intensity of the light beam, and
a control device configured to automatically adjust the distance between the first and second optics elements as a function of the light intensity measured by the measuring facility.

5. The flow apparatus of claim 1, wherein the flow apparatus includes a bypass system configured to introduce a further liquid into the measurement gap as a reference liquid.

6. The flow apparatus of claim 5, wherein the bypass system is configured, during operation, to automatically introduce a cleaning fluid and subsequently introduce the reference liquid into the measurement gap.

7. The flow apparatus of claim 1, wherein the flow apparatus has a tubular shape.

8. The flow apparatus of claim 1, wherein the elastic membrane is a polymer membrane or a mixed matrix membrane.

9. A method for operating a flow apparatus of a spectrometer system, wherein the flow apparatus has a first optics element optically coupleable to a spectrometer and a second optics element optically coupleable to a light source, the first and second optics elements being separated by a distance to define a measurement gap, and least one elastic membrane arranged between the first and second optics elements and an internal wall region of the flow apparatus, the method comprising:
communicating a flow of a liquid through the measurement gap between the first and second optics elements;
emitting a light beam from the light source such that at least a portion of the light beam passes through the second optics element, through the at least one elastic membrane, through the liquid flowing through the measurement gap, through the first optics element, and to the spectrometer,
wherein the light beam is at least partly absorbed by the liquid flowing through the measurement gap, and
changing the distance between the first and second optics element to control an amount of the liquid flowing through the measurement gap.

10. The method of claim 9, comprising adjusting the distance between the first and second optics elements during an ongoing operation of the spectrometer system.

11. The method of claim 9, comprising adjusting the distance between the first and second optics elements hydraulically or using a micrometer screw.

12. The method of claim 9, comprising:
using a measuring device optically coupled to the first optics element to measure a light intensity of the light beam, and
using a control device to automatically adjust the distance between the first and second optics elements as a function of the light intensity measured by the measuring facility.

13. The method of claim 9, comprising introducing a reference liquid into the measurement gap via a bypass system of the flow apparatus.

14. The method of claim 13, comprising automatically introducing a cleaning fluid into the measurement gap, and subsequently introducing the reference liquid into the measurement gap.
